(19) United States
(12) Patent Application Publication
(10) Pub. No.: US 2011/0228884 A1
(43) Pub. Date: Sep. 22, 2011

(54) METHOD AND DEVICE FOR FILTERING CHANNEL ESTIMATION RESULT IN ORTHOGONAL FREQUENCY DIVISION MULTIPLEXING

(75) Inventors: Ning Qiu, Guangdong Province (CN); Qiang Li, Guangdong Province (CN); Li Chen, Guangdong Province (CN); Nanshan Cao, Guangdong Province (CN); Tao Zhang, Guangdong Province (CN); Yueyi You, Guangdong Province (CN)

(73) Assignee: ZTE Corporation, Shenzhen Guangdong Province (CN)

(21) Appl. No.: 13/132,782

(22) PCT Filed: Sep. 3, 2009
(86) PCT No.: PCT/CN2009/073740

§ 371 Date: Jun. 3, 2011

(30) Foreign Application Priority Data
Dec. 5, 2008 (CN) 200810178929.8

(51) Int. Cl. H04B 1/10

(52) U.S. Cl. 375/350

(57) ABSTRACT

The invention provides a method and device for filtering orthogonal frequency division multiplexing (OFDM) channel estimate result, to solve the problems in the prior art that for channel estimate result filtering the realization is complex or the performance is poor. By embodiments the following method is described: transforming time domain synchronous symbols received by the terminal equipment to frequency domain synchronous symbols; computing frequency domain impulse response sequences based on the frequency domain synchronous symbols; adjusting least mean square (LMS) adaptive filter coefficients based on the frequency domain impulse response sequences; obtaining coefficients of the data symbol channel estimate result frequency domain filter based on the coefficients obtained from said adjusting; filtering the OFDM channel estimate result by using the data symbol channel estimate result frequency domain filter. The corresponding device is disclosed by the embodiments. There is less computation, simpler realization and better filtering performance provided with the OFDM channel estimate result frequency domain filter obtained from the technical solution of the present invention.

### FIELD OF THE INVENTION

The present invention relates to channel estimation field in communication and information technologies, in particular to a method and a device for filtering a channel estimation result in the Orthogonal Frequency Division Multiplexing (OFDM).

### BACKGROUND OF THE INVENTION

The State Administration of Radio Film and Television (SARFT) issued the China Mobile Multimedia Broadcasting Trade Standard in October, 2006, and determined to adopt the mobile television reception standard STiMi which is independently researched and developed by China. The standard has put into effect since Nov. 1, 2006. The China Mobile Multimedia Broadcasting (CMMB) is the first system which is independently researched and developed by China facing a plurality of mobile terminals such as mobile phone, personal digital assistant (PDA), MP3, MP4, digital camera, notebook computer and so on, utilizes a satellite signal on the S band to realize universal coverage and nationwide roaming, and supports 25 sets of television programs and 30 sets of broadcasting programs. The CMMB stipulates the channel coding, modulation and the frame structure of the transmission signal in the broadcast channel of the mobile multimedia broadcasting system in the range of broadcasting service frequencies. The standard is applicable to the broadcasting service frequencies within the frequency range from 30 MHz to 3000 MHz, and can realize the nationwide roaming by the satellite and/or the wireless broadcasting system on the ground which can transmit multimedia signals such as television, broadcasting, and data information and so on.

The CMMB standard adopts the orthogonal frequency division multiplexing (OFDM) technology which is a multicarrier modulation technology. The main principle of the OFDM is that: a channel is divided into a plurality of orthogonal sub channels, and high speed data is converted into low speed sub-data flows in parallel which can be modulated to each sub channel to be transmitted. Orthogonal signals can be separated at a receiving end by using related technologies, which can reduce the mutual interference among the sub channels. A signal bandwidth on each sub channel is less than the correlation bandwidth of the channel, so each sub channel can be regarded as flat fading, consequently the intersymbolic interference can be eliminated. Furthermore, the bandwidth of each sub channel is only a fraction of the original channel bandwidth, so that channel equalization is comparatively easy to realize. The OFDM has been used in many wireless system standards at present, such as European digital audio and digital video broadcasting system (DAB, DVB-T, DVB-H), 5 GHz high data rate wireless LAN (IEEE802.11a, HiperLan2, MMAC) system and so on.

The data subcarrier is multiple connected with scattered pilot and continuous pilot during the formation of frequency domain OFDM symbol of the CMMB system to form the OFDM frequency domain symbol. Each OFDM comprises Nv=3076 effective subcarriers.

The No. i effective subcarrier on the No. n OFDM symbol of each time slot is denoted as Xn(i), i=0, 1 . . . , Nv−1; 0≦n≦52. The effective subcarriers of the OFDM symbol are divided into data subcarriers, scattered pilots and continuous pilots as shown in FIG. 1.

In the above, M number of scattered pilots transmit known symbol 1+0j. The value selection rules of the serial number m of the effective subcarrier corresponding to the scattered pilot in the No. n OFDM symbol of each time slot are as follows:

$$if mod ( n , 2 ) == 0$$

$$m = \{ \begin{matrix}8 p + 1 , & p = 0 , 1 , 2 , … 191 \\ 8 p + 3 , & p = 192 , 193 , 194 , … 383\end{matrix} \\ if mod ( n , 2 ) == 1 \\ m = \{ \begin{matrix}8 p + 5 , & p = 0 , 1 , 2 , … 191 \\ 8 p + 7 , & p = 192 , 193 , 194 , … 383.\end{matrix}$$

A realization principle of a method for filtering a channel estimation in a frequency domain in prior art is as follows: a receiver receives time domain symbols transmitted in a wireless multi-path fading channel, performs FFT transformation to obtain frequency domain symbols, samples the M number of scattered pilot symbols in the frequency domain symbols, estimates the time domain pilot, takes the channel estimation result of the time domain frequency domain carrier as pilot data, and fills zero in the positions of the other subcarriers; then the N number of data after being filled is filtered by a filter with fixed tap coefficients. By using a frequency domain filter of a channel estimation result of a data symbol with fixed tap coefficients in the frequency domain, signal vector of the subcarrier can be averaged to eliminate noises, so that the precision of channel estimation is improved.

The above-mentioned principle of the method for filtering the channel estimation in the frequency domain can also be realized in the following mode: the receiver receives the time domain symbols transmitted in the wireless multi-path fading channel, performs FFT transformation to obtain the frequency domain symbols, samples the M number of scattered pilot symbols in the frequency domain symbols, estimates the time domain pilot, takes the channel estimation result of the time domain frequency domain carrier as the pilot data, and utilizes the linear interpolation technology or the high order interpolation technology to infer out the frequency filter coefficients of the channel estimation result of the data symbol corresponding to the channel of the data subcarrier except the positions of the scattered pilots. The method in the prior art has simple calculation and the least realization complexity, but also has poor performance.

The principle of another method for filtering the channel estimation in the frequency domain in prior art is as follows: the receiver receives the time domain symbols transmitted in a wireless multi-path fading channel, performs FFT transformation to obtain the frequency domain symbols, samples the M number of scattered pilot symbols in the frequency domain symbols, estimates the time domain pilot, takes the channel estimation result of the time domain frequency domain carrier as the pilot data, and fills zero in the positions of the other subcarriers; then the N number of data after being filled is input a frequency domain Wiener filter to obtain the frequency domain filter coefficients of the channel estimation result of the data symbol. The method in the prior art has optimum performance. But the autocorrelation matrix and crosscorrelation vector of the signal require to be estimated in order to calculate the coefficients of the Wiener filter, and the autocorrelation matrix requires performing matrix inversion calculation, the calculation is great, so as to influence the practical application severely.

The frequency domain filters of the channel estimation result of the data symbol mentioned above in the prior art all have the problems that the realization of filtering the channel estimation result is complex or the performance is poor. Therefore, a frequency domain filter of a channel estimation result of a data symbol with simple realization and better performance is required.

### SUMMARY OF THE INVENTION

The present invention mainly aims to provide a method for filtering a channel estimation in the frequency domain to solve the problems that the realization of filtering the channel estimation result is complex or the performance is poor in the prior art.

In order to solve the above-mentioned problems, the present invention provides a technical solution as follows.

A method for filtering a channel estimation result in the orthogonal frequency division multiplexing (OFDM) is provided according to one aspect of the present invention.

The method for filtering a channel estimation result in the OFDM according to the present invention comprises the following steps (step 1-step 5):

step 1, time domain synchronous symbols received by a terminal device are converted to frequency domain synchronous symbols;

step 2, frequency domain impulse response sequences are calculated according to the frequency domain synchronous symbols;

step 3, minimum mean square adaptive filter coefficients are adjusted according to the frequency domain impulse response sequences;

step 4, a coefficient of a frequency domain filter of a channel estimation result of a data symbol is obtained according to the adjusted coefficients; and

step 5, an OFDM channel estimation result is filtered by using the frequency domain filter of the channel estimation result of the data symbol.

A device for filtering a channel estimation result in the OFDM is provided according to another aspect of the present invention.

The device for filtering a channel estimation result in the OFDM according to the present invention comprises a frequency domain conversion module, an impulse response module, an adjustment module, a coefficient conformation module and a filter module, wherein,

the frequency domain conversion module is adapted to convert time domain synchronous symbols to frequency domain synchronous symbols;

the impulse response module is adapted to calculate frequency domain impulse response sequences according to the frequency domain synchronous symbols;

the adjustment module is adapted to adjust minimum mean square adaptive filter coefficients according to the frequency domain impulse response sequences;

the coefficient conformation module is adapted to obtain a coefficient of a frequency domain filter of a channel estimation result of a data symbol according to the adjusted coefficients; and

the filter module is adapted to use the frequency domain filter of the channel estimation result of the data symbol to filter an OFDM.

The technical solution of the present invention firstly utilizes the frequency domain channel impulse response sequences obtained according to the channel estimation result of the frequency domain of the synchronous symbol to adjust the minimum mean square adaptive filter coefficients, and then obtains the frequency domain filter coefficients of the channel estimation result of the data symbol according to the adjusted coefficients. The frequency domain filter of the channel estimation result of the data symbol obtained in this way can effectively filter the noise components of the channel estimation result of the frequency domain of the OFDM symbol. In addition, during the adjustment calculation of the minimum mean square adaptive filter coefficients, the calculation of the autocorrelation matrix and the crosscorrelation vector of the signal do not be required, and matrix inversion calculation of the autocorrelation matrix does not be required either. Therefore, the frequency domain filter of the OFDM channel estimation result obtained according to the technical solution of the present invention has less calculation, simpler realization and better filtering performance.

Other characteristics and advantages of the present invention will be described in the following specification, and will be apparent partly from the specification and will be understood by implementing the present invention. The objects and other advantages of the present invention can be realized and obtained by the specified structure of the specification, claims, and the drawings.

### BRIEF DESCRIPTION OF THE DRAWINGS

The drawings herein are used to provide further understanding of the present invention and form a part of the specification, which are used to explain the present invention with embodiments of the present invention rather than unduly limit the present invention. In the accompanying drawings:

FIG. 1 is a schematic diagram of an assigning mode in which the effective subcarriers of an OFDM symbol are assigned into data subcarriers, scattered pilots and continuous pilots.

FIG. 2 is a flow chart of a method in an embodiment of the present invention.

FIG. 3 is a schematic diagram of intercepting sample points in a channel time domain synchronous symbol in an embodiment of the present invention.

FIG. 4 is a structural schematic diagram of a FIR filter.

FIG. 5 is a flow chart of steps of an iterative calculation in an embodiment of the present invention.

FIG. 6 is a structural schematic diagram of a device in an embodiment of the present invention.

FIG. 7 is comparison schematic diagram of technical effect between a technical solution of an embodiment of the present invention and a technical solution of the prior art.

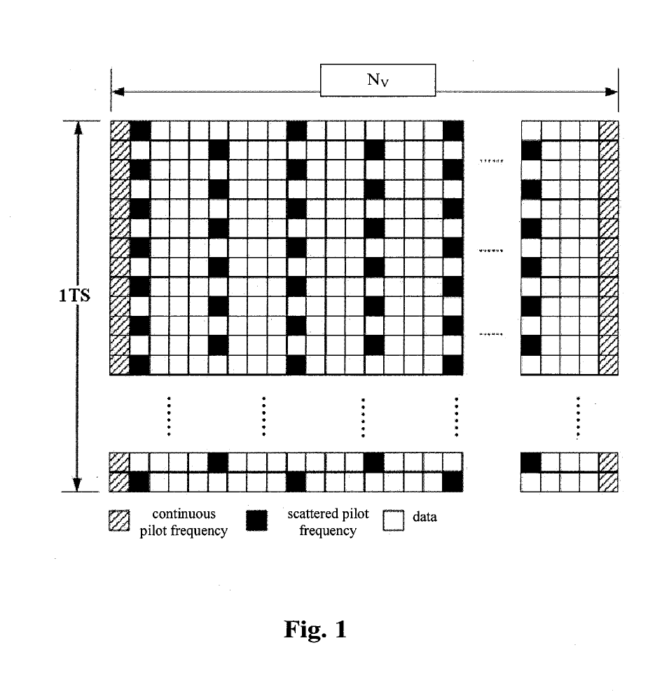

### DETAILED DESCRIPTION OF THE EMBODIMENTS

### Function Summary

In the embodiments of the present invention, by utilizing a frequency domain channel impulse response sequences obtained according to a channel estimation result in the frequency domain of the synchronous symbol to adjust a minimum mean square adaptive filter coefficients, and then obtains a frequency domain filter coefficients of the channel estimation result of the data symbol according to the adjusted coefficients. In addition, during the adjustment calculation of the minimum mean square adaptive filter coefficients, the calculation of the autocorrelation matrix and the crosscorrelation vector of the signal do not be required, and matrix inversion calculation of the autocorrelation matrix does not be required either, solves the problems that the calculation of the frequency domain filter in the prior art is great and the realization is complex.

In order to further understand the present invention, specific implementation modes and embodiments of the position advertising service de-massing method based on a regional strategy are described in detail hereinafter in connection with the embodiments and the drawings of the present invention. What should be understood is that the preferable embodiments described herein are given to illustrate and explain the present invention rather than limit the present invention.

If un-conflictive, the embodiments of the present invention and the features in the embodiments can be inter-combined with each other.

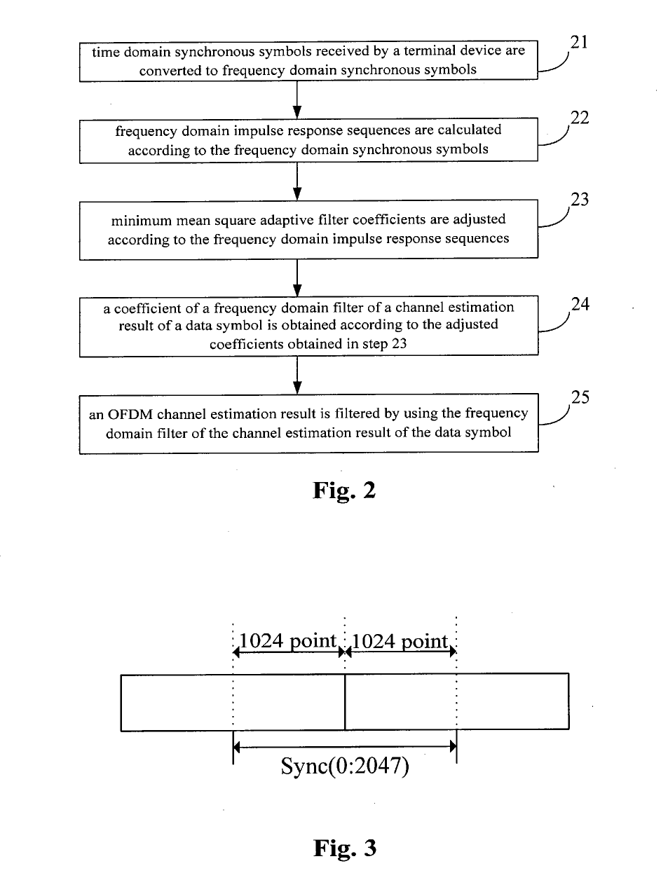

In order to realize the filtering of the channel estimation result of the OFDM simpler and obtain better filtering performance, the channel estimation result of the OFDM is processed according to the flow shown in FIG. 2 in an embodiment of the present invention. The process comprises the specific steps as follows (step 21-step 25).

Step 21, time domain synchronous symbols received by a terminal device are converted to frequency domain synchronous symbols.

Step 22, frequency domain impulse response sequences are calculated according to the frequency domain synchronous symbols.

Step 23, minimum mean square adaptive filter coefficients are adjusted according to the frequency domain impulse response sequences.

Step 24, a coefficient of a frequency domain filter of a channel estimation result of a data symbol is obtained according to the adjusted coefficients obtained in step 23.

Step 25, an OFDM channel estimation result is filtered by using the frequency domain filter of the channel estimation result of the data symbol.

The above-mentioned steps will be described in detail hereinafter.

The embodiments of the present invention will be described by taking a frame structure stipulated in the CMMB system as an example. According to the stipulation of the CMMB, the synchronous symbol locates at the starting location of each time slot. To be specific in step 21, firstly data is sampled from the time domain synchronous symbols received by the terminal device, and then the sampled data performs fast Fourier transform (FFT) to obtain the frequency domain synchronous symbols.

When the data is sampled from the time domain synchronous symbols received by the terminal device, 2048 sample points can be firstly intercepted from the time domain synchronous symbols received by the terminal device as the two 1024 sample points shown in FIG. 3. Besides the data interception mode as shown in FIG. 3, data at the other positions in FIG. 3 can also be intercepted. In the following data processing process, the solution of data interception at the other positions as shown in FIG. 3 requires using an initialization PN sequence which is different from the PN sequence of the embodiments of the present invention, while the other processes are the same to the embodiments of the present invention completely. The advantages of the sample point interception solution of the embodiments of the present invention exist in that, if timing offset exists, the intercepted data will not be contaminated except the synchronous symbols under the circumstance that the timing offset does not exceed positive 1024 or negative 1024 points. While for the other data interception solutions, as long as a certain direction of timing offset exists, the intercepted data will be contaminated by the other data besides the synchronous symbols.

The intermediate part of the time domain synchronous symbol, obtained by intercepting the data according to the mode as shown in FIG. 3, is Sync (0:2047). Then the data 0, 2, 4 . . . , 2046 is sampled in dot-interlaced mode from 0 point in the Sync (0:2047) and is re-combined into SyncD (0:1023)=Sync (0, 2, 4 . . . , 2046). Herein, the dot-interlaced sampled 1024 values are used to perform frequency domain conversion. The frequency domain conversion of the dot-interlaced sampled points reduces the highest frequency of a spectrum. In the following step 23, the spectrum component which is half less than the highest frequency is selected to perform calculation, in such a way the calculation can be decreased properly. After obtaining the SyncD (0:1023), the FFT can be performed on the SyncD (0:1023) to obtain the frequency domain synchronous symbol. The calculation can be performed according to the following formula:

$$SyncFreqD ( k ) = \frac{1}{2048} {\sum }_{i = 0}^{1023} ( SyncD ( i ) * {e}^{- j \frac{2 π k i}{1024}} )$$

After obtaining the frequency domain synchronous symbol, the frequency domain impulse response sequence will be calculated sequentially, i.e. the step 22. In this case, for the frequency domain synchronous symbol obtained in the step 21, the low frequency 256 points component is firstly intercepted from the frequency domain synchronous symbol except direct-current frequency component to construct a sequence FreqSyncDL(0:255)=FreqSyncD(1:256). Since spectral aliasing exists at the position half higher than the lowest frequency, data more than 256 points can not be used. Furthermore, a part of the low frequency 256 points can also be used as training sequence, but in this case, not all the data in the frequency domain synchronous symbol is used. Since longer training sequence length is favorable to reduce residual deviation of a filtering result and improve the performance of tracking variation of channels, the step 22 in the embodiment of the present selects the low frequency 256 points in the frequency domain synchronous symbol. After obtaining the data of the 256 points, the frequency domain impulse response sequence can be calculated. In the embodiment of the present invention, the data is intercepted according to the mode as shown in FIG. 3. Corresponding to the data interception mode as shown in FIG. 3, in the step 22, the FreqsyncDL(0:255) obtained by intercepting the low frequency 256 points component is multiplied by the PN sequence as shown in table 1, i.e., performing the calculation according to formula SyncCIR(0:255)=FreqSyncDL(0:255)·Pn(0:255), to obtain corresponding frequency domain impulse response sequence SyncCIR(0:255). If hardware fixed-point processing realization requirement requires to be met, in the embodiment of the present invention, SyncD (0:1023) can shift left for four bits and perform saturation processing in the step 21, and SyncCIR (0:255) can shift left for four bits and perform saturation processing in the step 22.

TABLE 1

| Serial number | Value selection |
|---|---|
| 0-63 | DF1E C611 6036 B727 |
| 64-127 | DDBF C283 A50C 8D7D |
| 128-191 | BBC0 32B5 A6CD 1582 |
| 192-255 | DB9C 1723 DF3E D219 |

After obtaining the frequency domain impulse response sequence SyncCIR (0:255) in the step 22, the step 23 will be executed sequentially. The sequence SyncCIR (0:255) is used as a training sequence of minimum mean square adaptive filter coefficients. The minimum mean square adaptive filter coefficients are adjusted by using an iterative calculation method to obtain a coefficients sequence W₂₅₆(i) of the minimum mean square adaptive filter. In the present step, it is set that Train (0:255)=SyncCIR (0:255), and then the iterative calculation is performed corresponding to each sampling time of the SyncCIR (0:255). To be specific, output values of the minimum mean square adaptive filter is performed the iterative calculation according to the order of the frequency domain impulse response sequence. After each time of the iterative calculation, the minimum mean square adaptive filter coefficients in the iterative calculation next time are adjusted according to the output value of the minimum mean square adaptive filter calculated in the iterative calculation this time. Lastly, the value obtained by adjusting the minimum mean square adaptive filter coefficients in the iterative calculation is output. The output value can be the minimum mean square adaptive filter coefficients calculated in the last iterative calculation, and the frequency domain filter of the channel estimation result of the data symbol obtained accordingly has good filtering performance. The specific steps of the iterative calculation will be described in detail in connection with FIG. 5 after the description of the steps shown in FIG. 2.

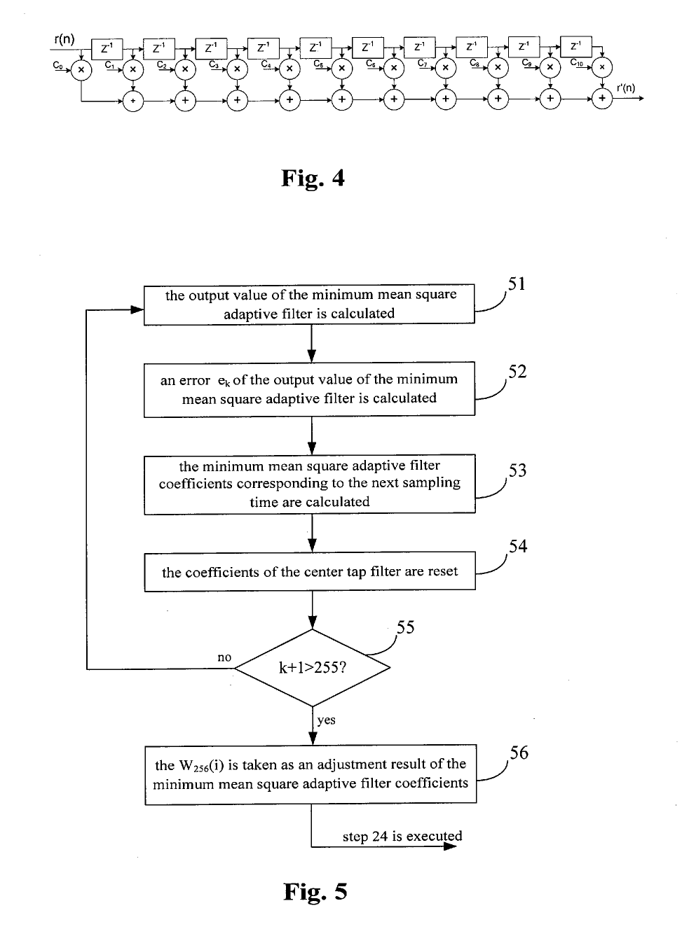

After obtaining the minimum mean square adaptive filter coefficients, in the step 24, in accordance with coefficient requirement of the frequency domain filter of the channel estimation result of the data symbol, the coefficients of the frequency domain filter of the channel estimation result of the data symbol are obtained according to the minimum mean square adaptive filter coefficients. In the embodiments of the present invention, the finite impulse response (FIR) filter is used. The FIR filter comprises a delayer, a multiplier, a summator and filter coefficients and so on. As shown in FIG. 4, r (n) is an input sequence, and the r′ (n) is an output sequence. The circle with mark Z⁻¹ is the delayer; the circle with mark × represents the multiplier; the circle with mark + is the summator; and C0-C10 are the filter coefficients and there are 11 coefficients in the FIG. 4. According to the structure of the FIR filter as shown in FIG. 4, in the embodiment of the present invention, the FIR filter coefficients are obtained according to the minimum mean square adaptive filter coefficients obtained in the step 23. To be specific, the process comprises the following steps: interpolation is firstly performed to the coefficients sequence obtained in the step 23, specifically, the W₂₅₆ (i) obtained in the step 23 is interposed with 0 with intervals to obtain Coeff (i). The interpolation can be performed according to the following formula:

$$Coeff ( i ) = \{ \begin{matrix}w ( i / 2 ) & i = 0 , 2 , 4 , … , 24 \\ 0 & i = else ;\end{matrix}$$

and then the Coeff (i) is truncated into 27 ranks by a half-band filter to calculate the FIR filter coefficients. The half-band filter with given ranks can be generated according to prior algorithm. The embodiment of the present invention selects a 20 ranks half-band filter used for converting the filter coefficients represented by floating point number into the filter coefficients represented by the fixed point number complement which is more favorable to realize hardware or software filter device. The Coeff (i) is performed calculation by the 20 ranks half-band filter, and the calculation is performed according to the following formula:

$$CoeffLp ( k ) = {\sum }_{i = 0}^{20} lpFilter ( i ) \cdot Coeff ( k + 8 - i ) ,$$

wherein k=0, 1, 2, . . . 27. 16 bits fixed point represents the 20 ranks half-band filter coefficients in the present step is as shown in table 2.

TABLE 2

| Index | Coefficient |
|---|---|
| 0 | 0 |
| 1 | 36 |
| 2 | 0 |
| 3 | −234 |
| 4 | 0 |
| 5 | 858 |
| 6 | 0 |
| 7 | −2555 |
| 8 | 0 |
| 9 | 10084 |
| 10 | 16384 |
| 11 | 10084 |
| 12 | 0 |
| 13 | −2555 |
| 14 | 0 |
| 15 | 858 |
| 16 | 0 |
| 17 | −234 |
| 18 | 0 |
| 19 | 36 |
| 20 | 0 |

After obtaining the CoeffLp (k), the step 25 will be executed, and the OFDM channel estimation result is filtered by using the FIR filter. For a FIR filter which has similar structure and only different coefficient numbers compared with the FIR filter as shown in FIG. 4, the OFDM channel estimation result is input the FIR filter from the position where the r (n) locates in FIG. 4, and the filter coefficients in the figure is replaced by the CoeffLp (k), then the filtering result of the FIR filter will be output from the position where the r′ (n) locates. The subsequent channel estimation result of the frequency domain of time slot OFDM symbols will also be filtered by the FIR filter.

The iterative steps in the step 23 will be described hereinafter in connection with FIG. 5.

Step 51, the output value of the minimum mean square adaptive filter is calculated. In the present step, the calculation can be performed according the following formula:

$${\hat{n}}_{k} = {\sum }_{i = 0}^{12} {w}_{k} ( i ) Train ( k - i + 12 ) ,$$

wherein, wₖ(i) is the minimum mean square adaptive filter coefficient, and \hat{n}ₖ is the output value of the minimum mean square adaptive filter. At the beginning of the iteration calculation, the value of the k is 0.

Step 52, an error eₖ of the output value of the minimum mean square adaptive filter is calculated according to the following formula: eₖ=Train(k+6)−\hat{n}ₖ.

Step 53, the minimum mean square adaptive filter coefficients, which will be used in the iteration calculation next to the present iteration calculation, are calculated. That is to say, the minimum mean square adaptive filter coefficients corresponding to the next sampling time are calculated. To be specific, the minimum mean square adaptive filter coefficients corresponding to the next sampling time of the SyncCIR(0:255) are calculated according to the following formula: wₖ₊₁(i)=wₖ(i)+eₖTrain(k−1+12)*, wherein, the sign * represents to perform conjugation calculation, i=0, 1, 2 . . . , 12.

Step 54, the coefficients of the center tap filter are reset, namely wₖ₊₁(6)=0. There are 13 coefficients in the embodiment of the present invention, so the sequence of the center tap is 6. Generally, if m numbers of coefficients are used, the serial number of the center tap will be (m−1)/2.

Step 55, it is judged whether the value of k+1 is more than 255, wherein if no, the step 51 is returned to perform the iteration calculation continuatively; if yes, the step 56 will be executed, the W₂₅₆(i) is taken as an adjustment result of the minimum mean square adaptive filter coefficients; and then the step 24 in FIG. 2 is executed.

The device in the embodiment of the present invention will be described hereinafter on the basis of the method in the embodiment of the present.

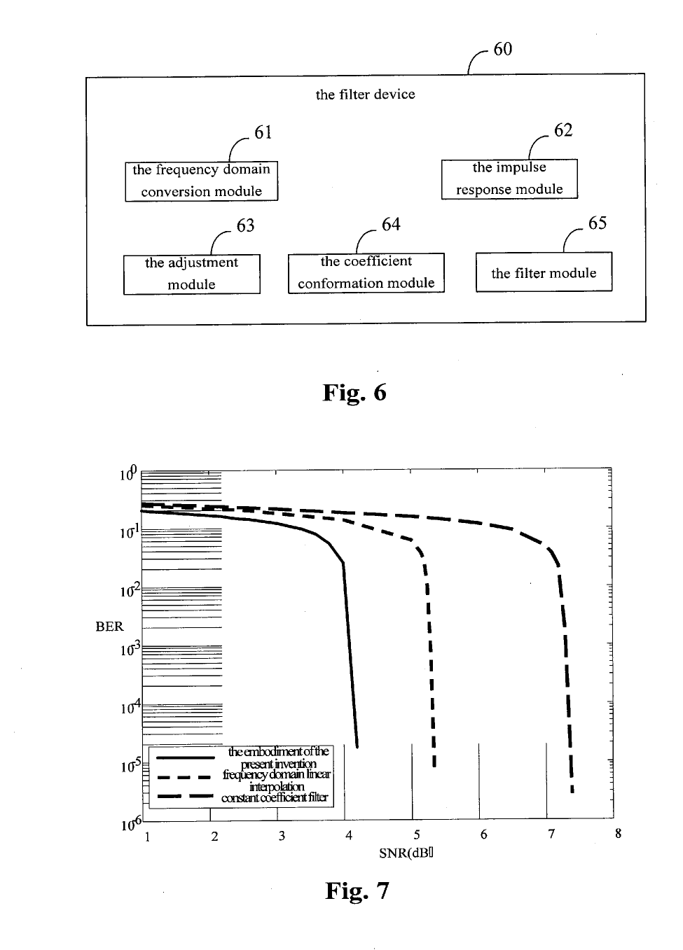

As shown in FIG. 6, a filter device 60 in the embodiment of the present invention comprises a frequency domain conversion module 61, an impulse response module 62, an adjustment module 63, a coefficient conformation module 64 and a filter module 65. The frequency domain conversion module 61 is adapted to convert time domain synchronous symbols received by a terminal device to frequency domain synchronous symbols. The impulse response module 62 is adapted to calculate frequency domain impulse response sequences according to the frequency domain synchronous symbols. The adjustment module 63 is adapted to adjust minimum mean square adaptive filter coefficients according to the frequency domain impulse response sequences. The coefficient conformation module 64 is adapted to obtain a coefficient of a frequency domain filter of a channel estimation result of a data symbol according to the adjusted coefficients obtained from the adjustment module 63. The filter module 65 is adapted to use the frequency domain filter of the channel estimation result of the data symbol to filter an OFDM.

One structure of the frequency domain conversion module 61 comprises a sampling unit and a conversion unit. The sampling unit is adapted to sample data from the time domain synchronous symbols received by the terminal device. The conversion unit is adapted to perform fast Fourier transform (FFT) to the data sampled by the sampling unit to obtain the frequency domain synchronous symbols.

One structure of the impulse response module 62 comprises an interception unit and an impulse response calculation unit. The interception unit is adapted to intercept low frequency points of the frequency domain synchronous symbols according to a pre-setting number to construct a low frequency sequence. The impulse response calculation unit is adapted to multiply the low frequency sequence by a frequency domain PN sequence whose position correspond to the low frequency sequence to obtain the frequency domain impulse response sequences.

One structure of the adjustment module 63 comprises an iteration calculation unit and a coefficient unit. The iteration calculation unit is adapted to iteratively calculate the minimum mean square adaptive filter coefficients according to the steps shown in FIG. 5. The coefficient unit is adapted to output values obtained by adjusting the minimum mean square adaptive filter coefficients during the iteration calculation.

One structure of the iteration calculation unit comprises an output value calculation sub-unit, an error calculation sub-unit, a coefficient adjustment sub-unit and a coefficient setting sub-unit. The output value calculation sub-unit is adapted to calculate the output value of the minimum mean square adaptive filter. The error calculation sub-unit is adapted to calculate an error of the output value of the minimum mean square adaptive filter. The coefficient adjustment sub-unit is adapted to calculate the minimum mean square adaptive filter coefficients, which is calculated in the present iteration calculation and will be used in the next iteration calculation during the iteration calculation, according to the calculation result of the error calculation sub-unit. The coefficient setting sub-unit is adapted to set a value of the No.

$$\frac{j - 1}{2}$$

coefficient of the minimum mean square adaptive filter coefficients, which is calculated in the present iteration calculation and will be used in the next iteration calculation during the iteration calculation, as 0.

One structure of the coefficient conformation module 64 comprises an interpolation unit and a half-band filter unit. The interpolation unit is adapted to interpose a value 0 after each element in a sequence output by the adjustment module, and then output the sequence. The half-band filter unit is adapted to calculate the sequence output by the interpolation unit by using a half-band filter and truncate which to obtain coefficients of the frequency domain filter of the channel estimation result of the data symbol.

The performance comparison between the technical solution of the embodiment of the present invention and the prior art in the circumstance of two ranks strong path channel with time delay 40 us expanded in the CMMB system is as shown in FIG. 7. It can be concluded from FIG. 7, comparing with the frequency domain linear interpolation and the constant coefficient in the prior art shown in the figure, the RS bit error rate of the filtering result of the filter obtained by the technical solution of the embodiment of the present invention is comparatively low.

The technical solution provided by the embodiments of the present invention utilizes the frequency domain channel impulse response sequences obtained according to the channel estimation result of the frequency domain of the synchronous symbol to adjust the minimum mean square adaptive filter coefficients, and then obtains the frequency domain filter coefficients of the channel estimation result of the data symbol according to the adjusted coefficients. The frequency domain filter of the channel estimation result of the data symbol obtained in this way can effectively filter the noise components of the channel estimation result of the frequency domain of the OFDM symbol. In addition, during the adjustment calculation of the minimum mean square adaptive filter coefficients, the iterative calculation adopted by the embodiments includes only hundreds of simple multiplication and addition. The calculation of the autocorrelation matrix and the crosscorrelation vector of the signal do not be required, and matrix inversion calculation of the autocorrelation matrix does not be required either. Therefore, the frequency domain filter of the OFDM channel estimation result obtained according to the technical solution of the present invention has less calculation, simpler realization and better filtering performance.

Obviously, for those skilled in the art, the present invention may have various changes and variations without deviating from the spirit and principle of the present invention. In this way, if the amendments and variations of the present invention are still within the scope of the claims and equivalent technologies of the present invention, the present invention also intends to include those amendments and variations within the protection scope of the present invention.

1. A method for filtering a channel estimation result in the orthogonal frequency division multiplexing (OFDM), comprising the following steps:
converting time domain synchronous symbols received by a terminal device to frequency domain synchronous symbols;
calculating frequency domain impulse response sequences according to the frequency domain synchronous symbols;
adjusting minimum mean square adaptive filter coefficients according to the frequency domain impulse response sequences;
obtaining a coefficient of a frequency domain filter of a channel estimation result of a data symbol according to the adjusted coefficients; and
using the frequency domain filter of the channel estimation result of the data symbol to filter an OFDM channel estimation result.

2. The method according to claim 1, wherein the step of converting the time domain synchronous symbols received by the terminal device to the frequency domain synchronous symbols comprises the following steps:
sampling data from the time domain synchronous symbols received by the terminal device according to a pre-setting mode; and
performing fast Fourier transform (FFT) to a sequence constructed by the sampled data to obtain the frequency domain synchronous symbols.

3. The method according to claim 1 wherein the step of calculating the frequency domain impulse response sequences according to the frequency domain synchronous symbols comprises the following steps:
intercepting low frequency points of the frequency domain synchronous symbols according to a pre-setting number to construct a low frequency sequence;
multiplying the low frequency sequence by a frequency domain PN sequence of position corresponding to the low frequency sequence to obtain the frequency domain impulse response sequences.

4. The method according to claim 1, wherein the step of adjusting the minimum mean square adaptive filter coefficients according to the frequency domain impulse response sequences comprises the following steps:
performing iterative calculation to an output value of the minimum mean square adaptive filter corresponding to each sampling time of the frequency domain impulse response sequences sequentially; and
the adjustment comprising adjusting the minimum mean square adaptive filter coefficients according to the result of the iterative calculation.

5. The method according to claim 4, wherein each time of the iterative calculation comprises the following steps:
calculating the output value of the minimum mean square adaptive filter;
calculating an error of the output value of the minimum mean square adaptive filter;
calculating the minimum mean square adaptive filter coefficients, which is calculated in the present iteration calculation and will be used in the next iteration calculation during the iteration calculation, according to the error; and
setting a value of the No.
$$\frac{j - 1}{2}$$
coefficient of the minimum mean square adaptive filter coefficients, which is calculated in the present iteration calculation and will be used in the next iteration calculation during the iteration calculation, as 0.

6. The method according to claim 5, wherein,
the step of calculating the output value of the minimum mean square adaptive filter comprises the step of calculating the output value \hat{n}ₖ of the minimum mean square adaptive filter according to the following formula:
$${\hat{n}}_{k} = {\sum }_{i = 0}^{j} {w}_{k} ( i ) Train ( k - i + 12 ) ;$$
wherein, the j is number of the minimum mean square adaptive filter coefficients; when k=0, wₖ(i) is a setting value of the minimum mean square adaptive filter coefficients;
the step of calculating the error of the output value of the minimum mean square adaptive filter comprises the step of calculating the error eₖ according to the following formula:
eₖ=Train(k+6)−\hat{n}*ₖ;
the step of calculating the minimum mean square adaptive filter coefficients, which is calculated in the present iteration calculation and will be used in the next iteration calculation during the iteration calculation, according to the error comprises performing the calculation using the following formula:
wₖ₊₁(i)=wₖ(i)+eₖTrain(k−i+12)*;
wherein, wₖ₊₁(i) is the minimum mean square adaptive filter coefficients used in the next iteration calculation; Train(k−i+12)* represents a conjugate value of Train(k−i+12); and
the adjusted coefficients comprises the wₖ(i), wherein a value of the k equals to the length of the frequency domain impulse response sequences.

7. The method according to claim 4, wherein the frequency domain filter of the channel estimation result of the data symbol comprises a finite impulse response (FIR) filter;
the step of obtaining the coefficients of the frequency domain filter of the channel estimation result of the data symbol according to the adjusted coefficients comprises the following steps:
interposing a value 0 after each element in a sequence constructed by the adjusted coefficients;
calculating the sequence obtained after interposing the value 0 by using a half-band filter and truncating which to obtain coefficients of a FIR filter;
the step of using the frequency domain filter of the channel estimation result of the data symbol to filter the OFDM channel estimation result comprises:
using the FIR filter to filter the OFDM channel estimation result.

8. A device for filtering a channel estimation result in the orthogonal frequency division multiplexing (OFDM), comprising:
a frequency domain conversion module, adapted to convert time domain synchronous symbols to frequency domain synchronous symbols;
an impulse response module, adapted to calculate frequency domain impulse response sequences according to the frequency domain synchronous symbols;
an adjustment module, adapted to adjust minimum mean square adaptive filter coefficients according to the frequency domain impulse response sequences;
a coefficient conformation module, adapted to obtain a coefficient of a frequency domain filter of a channel estimation result of a data symbol according to the adjusted coefficients; and
a filter module, adapted to use the frequency domain filter of the channel estimation result of the data symbol to filter an OFDM.

9. The device according to claim 8, wherein the frequency domain conversion module comprises:
a sampling unit, adapted to sample data from the time domain synchronous symbols received by the terminal device; and
a conversion unit, adapted to perform fast Fourier transform (FFT) to a sequence constructed by the data sampled by the sampling unit to obtain the frequency domain synchronous symbols.

10. The device according to claim 9, wherein the impulse response module comprises:
an interception unit, adapted to intercept low frequency points of the frequency domain synchronous symbols according to a pre-setting number to construct a low frequency sequence;
an impulse response calculation unit, adapted to multiply the low frequency sequence by a frequency domain PN sequence whose position correspond to the low frequency sequence to obtain the frequency domain impulse response sequences.

11. The device according to claim 10, wherein the adjustment module comprises:
an iteration calculation unit, adapted to perform iterative calculation to an output value of the minimum mean square adaptive filter corresponding to each sampling time of the frequency domain impulse response sequences sequentially; and
a coefficient unit, adapted to obtain and output the minimum mean square adaptive filter coefficients according to the iterative calculation result of the iteration calculation unit.

12. The device according to claim 11, wherein the iteration calculation unit comprises:
an output value calculation sub-unit, adapted to calculate the output value of the minimum mean square adaptive filter;
an error calculation sub-unit, adapted to calculate an error of the output value of the minimum mean square adaptive filter;
a coefficient adjustment sub-unit, adapted to calculate the minimum mean square adaptive filter coefficients, which is calculated in the present iteration calculation and will be used in the next iteration calculation during the iteration calculation, according to the error;
a coefficient setting sub-unit, adapted to set a value of the No.
$$\frac{j - 1}{2}$$
coefficient of the minimum mean square adaptive filter coefficients, which is calculated in the present iteration calculation and will be used in the next iteration calculation during the iteration calculation, as 0.

13. The device according to claim 8, wherein the coefficient conformation module comprises:
an interpolation unit, adapted to interpose a value 0 after each element in a sequence output by the adjustment module, and then output the sequence;
a half-band filter unit, adapted to calculate the sequence output by the interpolation unit by using a half-band filter and truncate which to obtain coefficients of the frequency domain filter of the channel estimation result of the data symbol.
